(19) United States
(12) Patent Application Publication
(10) Pub. No.: US 2003/0097559 A1
(43) Pub. Date: May 22, 2003

(54) Qualification authentication method using variable authentication information

(75) Inventors: Akihiro Shimizu, Kochi-shi (JP); Mitsuyoshi Shibuya, Tokyo (JP)

Correspondence Address: DARBY & DARBY P.C, 805 Third Avenue, New York, NY, 10022, US

(73) Assignee: NTT Advanced Technology Corporation; and Akihiro Shimizu

(21) Appl. No.: 10/294,005

(22) Filed: Nov. 13, 2002

(30) Foreign Application Priority Data
Nov. 16, 2001 (JP) 2001-352445

(51) Int. Cl. H04L 9/00

(52) U.S. Cl. 713/155; 713/161

(57) ABSTRACT

A person to be authenticated generates authentication data for this time and authentication data for next time using a one-way function, based on a user ID, a password and a random number, and performs an exclusive OR operation on these, to thereby encrypt the data while associating the both parameters with each other, and transmits these data together with the own user ID to an authenticating person. The authenticating person receives the aforesaid three informations, compares a validity confirmation parameter calculated by using a one-way function based on the authentication data for this time with a authentication parameter registered in the previous authentication phase, and when these parameters agree with each other, judges that authentication is approved, and registers the authentication data for next time as the authentication parameter for next time.

### BACKGROUND OF THE INVENTION

1. Field of the Invention

The present invention relates to a qualification authentication method for an authenticating person to authenticate a person to be authenticated. An authentication method using variable authentication information is a method for performing authentication by changing authentication information such as passwords for each request of authentication from the person to be authenticated to the authenticating person.

2. Background Art

Conventional methods for authenticating the qualifications of a communicates or a user, using authentication information such as a password can be divided roughly into two, namely; applying public key cryptography, and applying common key cryptography. In the incorporation into Internet-related communication protocols, a method which applies common-key type cryptography capable of considerably higher speed processing than the public key cryptography, in particular, a password authentication method is generally used. The procedure of the basic password authentication is as follows. At first, a person to be authenticated (including an apparatus) registers a password with an authenticating person (including an apparatus such as a server). At the time of authentication, the person to be authenticated transmits a password to the authenticating person. The authenticating person compares the received password with the registered password, and performs authentication.

However, this method has problems as described below:

(a) The password may be stolen by furtive viewing of password files on the authentication side;

(b) The password may be stolen by line tapping during communication; and

(c) The person to be authenticated is required to disclosure the password that is his/her own secret information to the authenticating person.

As a method for solving the first problem (a), there is a method wherein for example, a person to be authenticated registers data obtained by applying a one-way function to the password with the authenticating person, and at the time of authentication, the authenticating person applies the same one-way function to the received password, to thereby compare the results. The following documents can be raised as references:

A. Evans, W. Kantrowitz and E. Weiss: “A user authentication scheme not requiring secrecy in the computer,” Commun. ACM, 17, 8, pp. 437-442 (1974); and

R. Morris and K. Thompson: “Password security: A case history” UNIX Programmer's Manual, Seventh Edition, 2B (1979)).

A one-way function is a function where there is no efficient means for obtaining an input from an output, other than a round robin to the input (trying to input all possible numbers), and by making the computational complexity of the round robin sufficiently large, an unqualified person can be prevented from calculating the input data and successfully pretending to be a person to be authenticated. In general, the one-way function can be performed by key cryptography such as DES and FEAL. The common key cryptography is for processing a plaintext input by using a common private key (secret key) to obtain this as a cipher text, and even if the plaintext and the cipher text are provided, the common private key cannot be calculated. Particularly FEAL is characterized in that it can obtain an output which leaves no trace of the input change, if the input of the plaintext and the common private key changes only one bit.

As described above, the basic problem (a) in the password authentication method can be solved by the method using the one-way function. However, if this method is applied for the Internet in which line tapping is easy, the problem (b) cannot be solved. Moreover, with regard to the problem (c), this basic password authentication method is applicable for customer authentication of banks, but is not suitable for qualification authentication between users of the same level.

As a method for solving such a problem, there is a qualification authentication method in which authentication information such as a password is made variable. For example, there can be mentioned a method of Lamport “S/KEY type password authentication method (L. Lamport, “Password authentication with insecure communication”, Communications of the ACM, 24, 11, pp. 770-772 (1981), and a CINON method (Chained One-way Data Verification Method) which is a dynamic password authentication method proposed by the present inventor. References can be raised such as:

A. Shimizu, “A Dynamic Password Authentication Method Using a One-way Function” Systems and Computers in Japan, Vol. 22, No. 7, 1991, pp. 32-40;

Japanese Patent Application, Second Publication No. Hei 8-2051 (Japanese Patent No. 2098267) titled “Qualification Authentication method”;

Japanese Patent Application No. Hei 8-240190 titled “Information Transfer Control Method having User Authentication Function”; and

Japanese Patent Application No. Hei 11-207325 titled “Qualification Authentication Method Using Variable Authentication Information”.

The Lamport method is a method in which a one-way function is applied to the password several times, and the data obtained by the previous application is shown sequentially to the authenticating person side, thereby enabling a plurality of authentications. With this method, a “1” is subtracted each time authentication is executed, from an initially set maximum authentication number of times, and at the time of using up the authentication number of times, it is necessary to reset the password. If the application number of the one-way function is increased in order to increase the maximum authentication number of times, the throughput increases. In the customer authentication of banks, several hundreds to 1,000 or the like are used as the maximum authentication number of times. In general, because the processing capability on the side of the person to be authenticated is smaller than that on the authenticating person side, there is a problem in that the processing burden on the authenticating person side is large.

The CINON method is a method wherein three data: that is, original data of the authentication data whose validity has been verified at the last time and which is now registered; the authentication data which will be used for authentication at the time of one after next; and validity verification data of the authentication data to be used for the next authentication which has been transmitted last time, are transmitted to the authenticating person (host) for each authentication phase, to thereby enable chain authentication sequentially, while safely updating the authentication information. In this manner, with the CINON method, it is necessary to use two random numbers N₍ₖ₋₁₎, and N₍ₖ₎ generated at the last time, for a person to be authenticated to obtain authentication of the authenticating person. Therefore, when a user obtains authentication of the authenticating person from a terminal at a place where the user is visiting, the user has to carry a storage medium, for example, an IC card or the like, in which these random numbers are stored, and use it on the terminal at the place where the user is visiting. Moreover, the terminal requires a function for generating random numbers and a function for reading and writing the IC card. On the other hand, in the Internet, products referred to as “Internet electric household appliances” wherein an Internet connection function is added to TV sets, word processors, portable terminals or the like are to be put on the market.

Accompanying popularization of such Internet electric household appliances, demand for the transfer of information having authentication processing will increase. However, with Internet electric household appliances, since the cost is regarded as most important, most of these do not have a function for generating random numbers as described above and a function for reading and writing to a storage medium such as an IC card. Moreover, since the storage area of the processing program is also limited, it is desired to realize such authentication processing with a program size as simple and small as possible.

To solve these problems, a user authentication method in “Information Transfer Control Method having User Authentication Function” (Japanese Patent Application, First Publication No. Hei 10-145356 (Japanese Patent Application No. Hei 8-240190)) proposed by the present inventor of the present application, is for providing a safe information transfer control method and an apparatus thereof, and a recording medium which stores the method, which does not require a function for reading and writing to a storage medium such as an IC card on the side of a person to be authenticated, and which can perform the user authentication processing with a small program size, in the information transfer between a person to be authenticated and an authenticating person on networks where security is not sufficiently ensured, such as the Internet. In the authentication procedure, the main feature is that, as an improvement of the CINON method, authentication number of times is used, instead of random numbers used at the time of generating the authentication data, as a parameter which must be synchronized between a user to be authenticated and an authenticating server, in order to make the value of various authentication data be required only once. The processing which must be performed by the user to be authenticated becomes slightly simpler than in the above described “qualification authentication method”. According to this invention, common key cryptography such as DES and FEAL is used for the one-way function used for generation of the authentication data. Therefore, the safety depends on the one-way function to be used, that is, the strength of the common key cryptography, and there is no influence due to the change from random numbers to the authentication number of times.

Furthermore, in the user authentication method in “Qualification Authentication Method Using Variable Authentication Information” (Japanese Patent Application, First Publication No. 2001-036522 (Japanese Patent Application No. Hei 11-207325)) proposed by the present inventor of the present application, a person to be authenticated generates a random number at each of the authentication phases. The this time authentication data and the next time authentication data are calculated using a one-way function based on the random number, a user ID, and password, and furthermore, the this time authentication data and the next time authentication data are encrypted using an exclusive OR operation so that persons except for the person to be authenticated cannot read the data. The exclusive OR for this time authentication and an exclusive OR for next time authentication are transmitted to the authenticating person (including apparatus such as a server) together with the used ID of the person to be authenticated. On the other hand, the authenticating person receives the three information from the person to be authenticated, and compares the validity confirmation parameter calculated using the one-way function based on the this time authentication data and the authentication parameter previously registered in the previous authentication phase. If these parameters agree with each other, the authenticating person judges that the present authentication is approved, the authentication data for the next time is registered as the next time authentication parameter. Therefore, in an authentication method for letting the authenticating person authenticate the person to be authenticated on networks where security is not sufficient, the throughput (computational complexity) executed by the person to be authenticated and the authenticating person can be considerably reduced for each authentication phase. Additionally, it is possible to execute the method with a small program size on the side to be authenticated and the authenticating side, and to perform safe authentication with high resistance against tapping on the communication line.

The authentication method in the above described four methods is a qualification authentication method using variable authentication information. The important feature of such a qualification authentication method is that since the data for authentication delivered from a person to be authenticated to an authenticating person through a data transmission channel such as the Internet is different for each authentication phase (different each time), even if the data is tapped in a certain authentication phase, another authentication data must be sent from the person to be authenticated to the authenticating person for authentication at the next authentication phase (at the time of next authentication). Therefore, an unqualified person who tapped the data cannot successfully pretend to be the right person to be authenticated.

In the Lamport method, there are problems in that the throughput (computational complexity) on the user side to be authenticated is considerably large and that the person to be authenticated is required to update the password regularly.

In the CINON method, the necessity of password update which is a disadvantage in the Lamport method can be removed, but there is still the problem that the throughput (computational complexity) for the person to be authenticated and the authenticating person is large.

The user authentication method in the “Information Transfer Control Method having User Authentication Function” can reduce the throughput (computational complexity) for the person to be authenticated, which is a disadvantage in the CINON method. However, there is a problem in that the procedure between the person to be authenticated and the authenticating person is slightly complicated, and there are lots of data that must be managed corresponding to users on the authenticating server side, and at the time of actual operation, it is necessary to deliberately study the processing procedure of a semi-normal system and an abnormal system.

The user authentication method in the “Qualification Authentication Method Using Variable Authentication Information” can reduce the disadvantages in “Information Transfer Control Method having User Authentication Function” such as that there are many data to be managed, and that the processing procedure of a semi-normal system and an abnormal system is difficult. However, because this time authentication data and next time authentication data are independent from each other, if the user ID and the this time authentication data are unchanged, the authentication is approved only by this fact. Furthermore, if a malicious third party alters only next time authentication data, because the authentication is approved and the altered data is processed as next authentication data, there is a risk that the authentication of the right user is prevented by the alteration from being approved.

### SUMMARY OF THE INVENTION

It is an object of the present invention to provide a qualification authentication method using variable authentication information for an authenticating person to authenticate a person to be authenticated on networks where security is not sufficient, wherein the throughput (computational complexity) executed on the sides of the person to be authenticated and the authenticating person for each authentication phase is made considerably small, thereby enabling simple authentication with a small program size for both sides, namely the person to be authenticated and the authenticating person, and the performance of safe authentication which is strong against tapping on the communication line.

To achieve the above object, the qualification authentication method using variable authentication information of the present invention is a qualification authentication method in which a person to be authenticated can be authenticated by an authenticating person without giving a password secretly held by the person to be authenticated, and the authentication information transmitted each time the person to be authenticated requests authentication to the authenticating person is made variable, wherein the method comprises an first-time registration phase and an authentication phase;

the first-time registration phase includes:

a step in which the person to be authenticated generates first-time authentication data by using a one-way function, which generates output one-way (irreversible) information which makes it difficult to calculate input information in terms of computational complexity, based on an own user ID, password and a random number;

a step in which the person to be authenticated transmits an own user ID and the first-time authentication data to the authenticating person; and

a step in which the authenticating person registers the first-time authentication data received from the person to be authenticated as an authentication parameter used at the time of first-time authentication; and

the authentication phase includes:

a step in which the person to be authenticated generates, intermediate data for this time authentication data, this time authentication data, next time authentication data, and an intermediate parameter for certification of authentication, using the one-way function based on the own user ID, password and a random number; and performs an exclusive OR operation using the intermediate parameter for certification of authentication, with respect to the intermediate data for this time authentication data, and an exclusive OR operation using the this time authentication data with respect to the next time authentication data, to thereby generate an exclusive OR for this time authentication and an exclusive OR for next time authentication;

a step in which the person to be authenticated transmits the own user ID, the exclusive OR for this time authentication and the exclusive OR for next time authentication to the authenticating person;

a step in which the authenticating person generates a temporary parameter for next time certification based on the exclusive OR of the exclusive OR for next time authentication received from the person to be authenticated and the authentication parameter registered in the previous time, and generates an intermediate parameter for certification of authentication using the one-way function from the temporary parameter for next time authentication;

a step in which the authenticating person generates a validity confirmation parameter for the person to be authenticated, using the one-way function and designating, as the input information, an exclusive OR of the exclusive OR for this time authentication received from the person to be authenticated and the intermediate parameter for certification of authentication, compares the validity confirmation parameter and the previously registered authentication parameter, and if these parameters agree with each other, the authenticating person judges that the authentication is approved, and if these parameters do not agree with each other, the authenticating person judges that the authentication is not approved; and

a step in which when the authentication is approved, the temporary parameter for next time authentication is registered as an authentication parameter for next time authentication instead of the previously registered authentication parameter;

the above described steps being sequentially continued to thereby perform authentication of the person to be authenticated.

That is to say, according to the present invention, the person to be authenticated (including apparatus) generates a random number for each authentication phase, calculates this time authentication data, next time authentication data, and an intermediate parameter for certification of authentication using a one-way function, based on the random number, user ID and password, associates these data using the exclusive OR operation to encrypts these data so that only the person to be authenticated can decrypt the data, and transmits the exclusive OR for this time authentication and the exclusive OR for next time authentication together with the own user ID of the person to be authenticated to an authenticating person (including apparatus such as a server). Moreover, the authenticating person receives the above described three informations from the person to be authenticated, calculates a validity confirmation parameter using the one-way function based on these information and the authentication parameter registered in the previous authentication phase, compares the validity confirmation parameter with the authentication parameter registered in the previous authentication phase, and if these agree with each other, judges that this time authentication is approved, and registers the decoded next time authentication data as the next time authentication parameter.

As a result, with the present invention, the following effects can be obtained:

(1) Only one transmission is required from a person to be authenticated to an authenticating person, whereas in the above described related art, transfer of authentication-related information performed between the person to be authenticated and the authenticating person at the time of executing one-time authentication processing, must be performed one round trip and once half way (transfer of three times in total), as seen from the person to be authenticated.

(2) In the above described related art, there are four authentication-related data managed by the authenticating person for each person to be authenticated, but with this method, only one data is necessary.

(3) Encoding or decoding processing other than the exclusive OR operation on the sides of the person to be authenticated and the authenticating person for each authentication phase is reduced to two times on the authenticating side, and to five times on the side of the person to be authenticated. Thereby, there can be obtained excellent effect in that the throughput (computational complexity) executed by the person to be authenticated and the authenticating person can be considerably reduced.

(4) If the exclusive OR for this time authentication and the exclusive OR for next time authentication are altered by illegal operations on the communication line, because these exclusive ORs are associated with each other using complex calculation by the one-way function in the authentication process, authentication cannot be performed. Therefore, the authentication parameter cannot be altered, the safety in the authentication can thereby improved.

Furthermore, it is preferable to use a function used for private key cryptography such as DES and FEAL as the one-way function E. In this case, decoding of the authentication information becomes impossible, and FEAL realizes high speed encoding processing.

### BRIEF DESCRIPTION OF DRAWINGS

FIG. 1 is a diagram showing an first-time registration phase of an embodiment of a qualification authentication method according to the present invention.

FIG. 2 is a diagram showing an first-time authentication phase of the qualification authentication method.

FIG. 3 is a diagram showing the k-th time authentication phase of the qualification authentication method.

FIG. 4 is a block diagram showing an embodiment of a system for performing the qualification authentication method.

### DESCRIPTION OF THE PREFERRED EMBODIMENTS

Hereinafter, preferable embodiments of the present invention will be explained. However, the present invention is not limited to only the embodiments, but can be variously modified in the scope of the claims.

Prior to the explanation of the qualification authentication method using variable authentication information according to the present invention, a one-way function will first be described. The one-way function is a function wherein there is no effective method of counting back the input data from the output data, other than by examining the input data one by one. Such a property can be realized, using a private key encryption algorithm such as DES, FEAL or the like. Particularly, FEAL is an excellent private key cryptography that realizes encryption processing speeds of 200 Kbps with the software on a personal computer of 16 bits and 96 Mbps (clock 10 MHz) as the LSI.

The private key encryption algorithm is represented by C=E (P_{A}, S_{B}). E denotes a one-way function (private key encryption processing function, the second parameter is the private key), C is a cipher text, P_{A} is a plaintext and S_{B} is a private key. If it is assumed that P_{A} is a plaintext and S_{B} is input information, and C is output information, even if the plaintext P_{A} and the output information C are known, the input information S_{B} cannot be counted back.

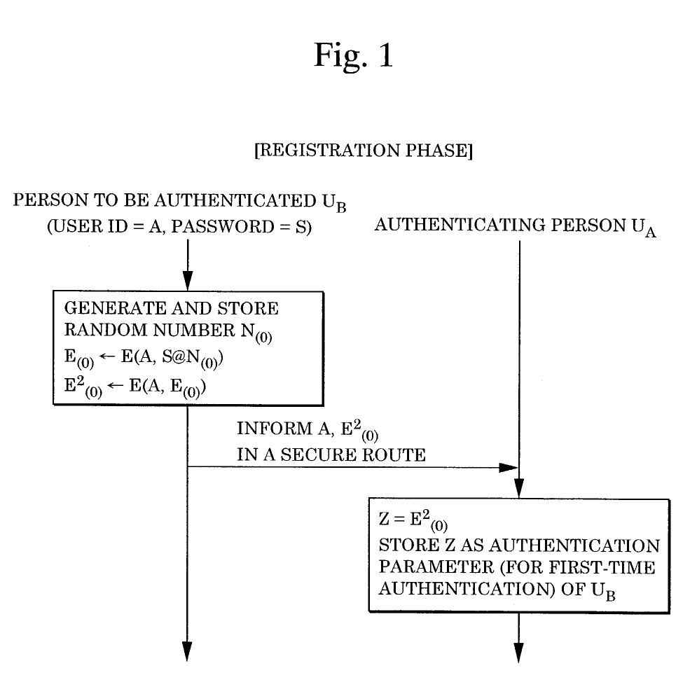

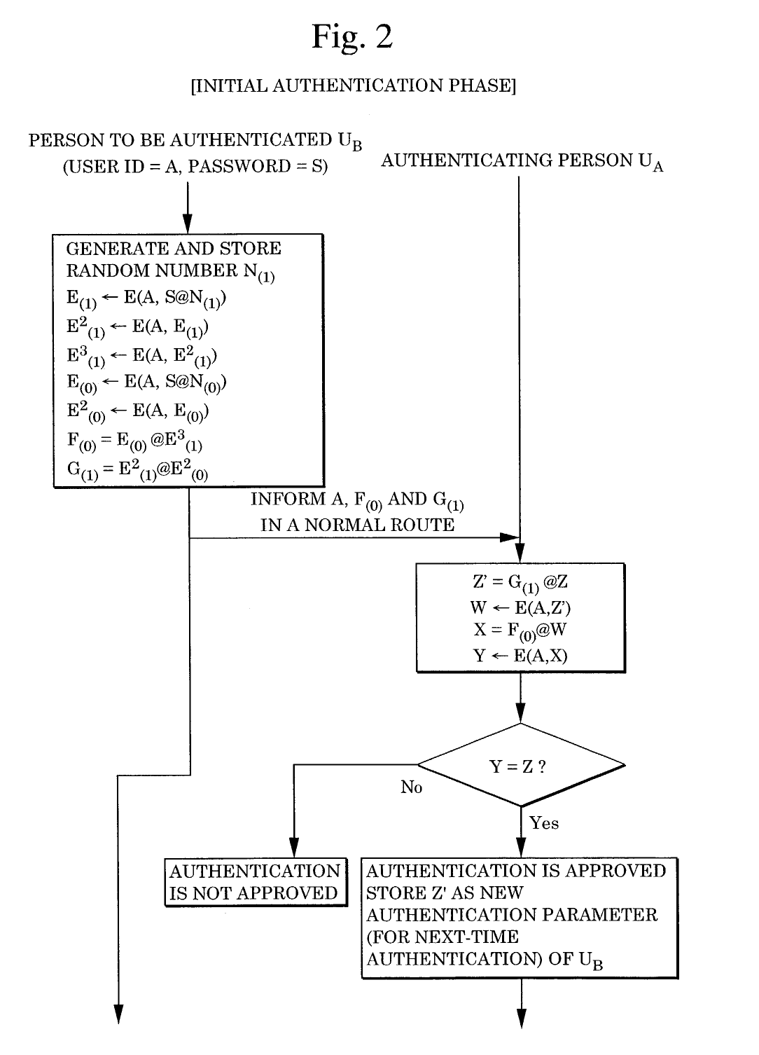

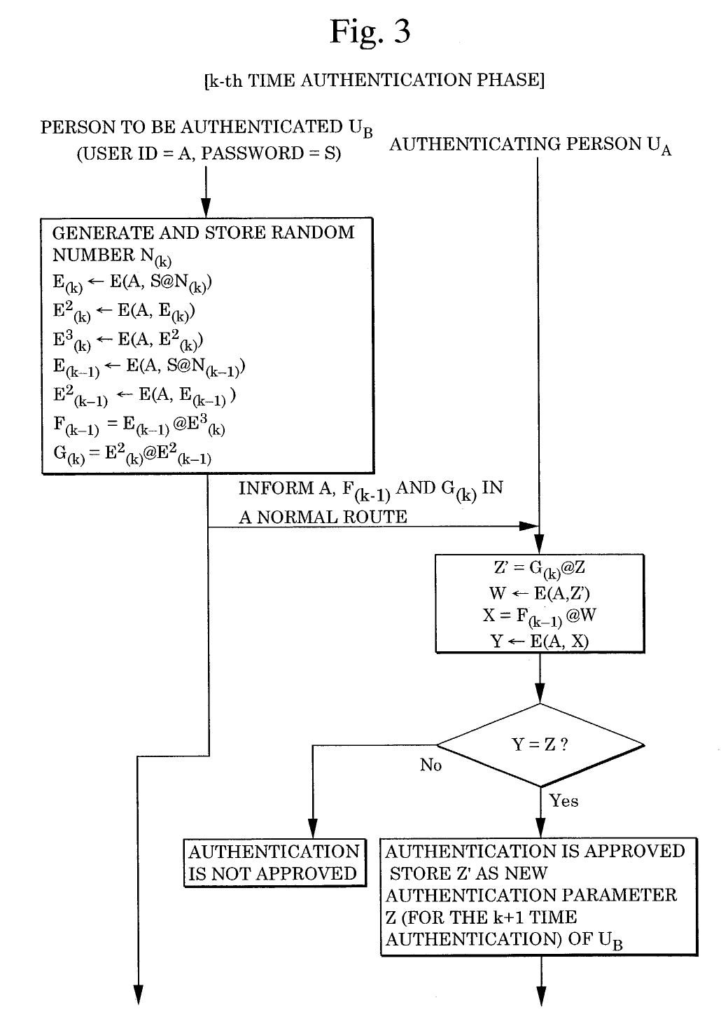

Next, an embodiment of the qualification authentication method of the present invention will be described. The data flow of the authentication method in the first embodiment is shown in FIG. 1 to FIG. 3. FIG. 1 shows the data flow in the first-time registration phase, FIG. 2 shows the data flow in the first-time authentication phase and FIG. 3 shows the data flow in the k-th time authentication phase. Data flows downward from the top or along an arrow. In these figures and the description below, one-way operation C=E (P_{A}, S_{B}) is expressed as C←E (P_{A}, S_{B}). Also, the exclusive OR operator is denoted by @.

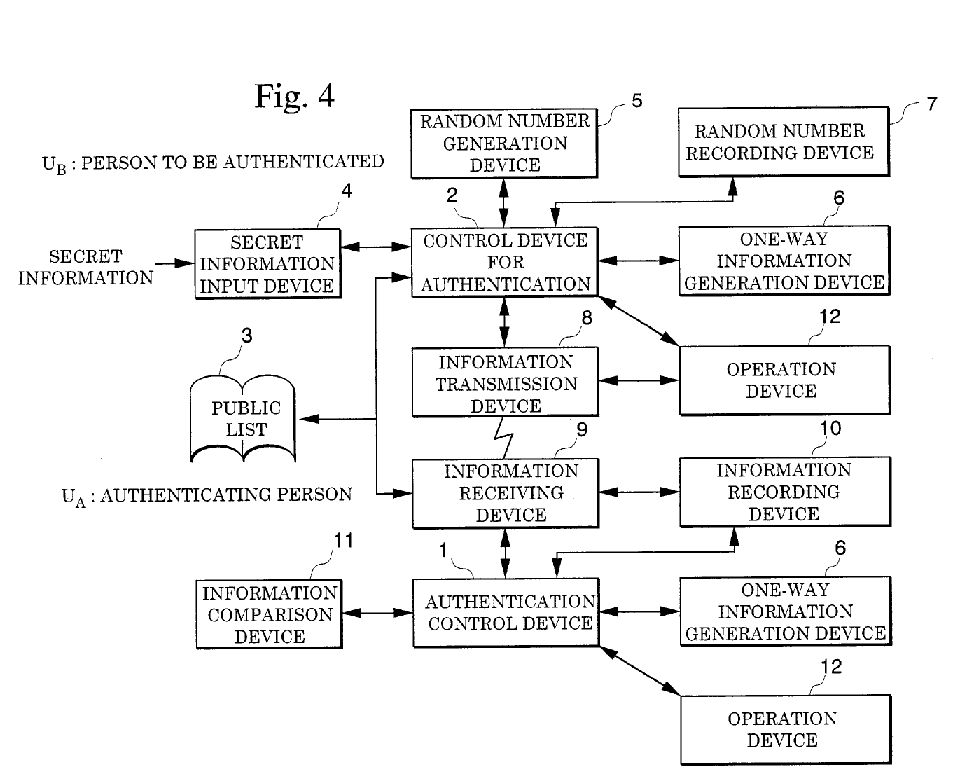

FIG. 4 shows an embodiment of a function block for realizing the qualification authentication method of the present invention. In FIG. 4, 1 denotes an authentication control device, 2 denotes a control device for authentication, 3 denotes a public list, 4 denotes a secret information input device, 5 denotes a random number generation device, 6 denotes a one-way information generation device, 7 denotes a random number recording device, 8 denotes an information transmission device, 9 denotes an information receiving device, 10 denotes an information recording device, 11 denotes an information comparison device and 12 denotes an operation device. In this embodiment, the authentication procedure is shown, designating an authenticating person U_{A} as an authenticating server, and a person to be authenticated U_{B} as a user to be authenticated. The user to be authenticated U_{B} is assumed to have an own user ID=A opened to the public as P_{A}, and a password S which the user secretly manages by himself/herself, and an exclusive OR of the password S and a random number is used as S_{B}.

The authentication method in this embodiment is mainly composed of two phases; the first-time registration phase and the authentication phase thereafter. The authentication phase is sequentially repeated, as first time, second time, third time and so on. The authentication control of the authenticating server U_{A} is performed by the authentication control device 1. The control for authentication for the user to be authenticated U_{B} is performed by the control device for authentication 2. Also, the above described user ID: A is registered in the public list 3.

[First-Time Registration Phase]

The first-time registration phase will first be described.

(1) On the Side of the User U_{B} to be Authenticated (Arithmetic Processing)

The password S is taken in by the secret information input device 4. P_{A}=A is used as the own user ID. N₍₀₎ is optionally set by the random number generation device 5, and stored by the random number recording device 7. The following data is calculated by the one-way information generation device 6. As the one-way function, a private key encryption processing function E is used. At first, the first time authentication intermediate data E₍₀₎←E (A, S@N₍₀₎) is generated, and the first time authentication data E²₍₀₎←E (A, E₍₀₎) is also generated.

(2) On the Side of the User U_{B} to be Authenticated (Transmission Processing)

After having performed the preparations described above, User ID: A and first-time authentication data E²₍₀₎ are transmitted to the authenticating server U_{A} by the information transmission device 8 to thereby request registration. In this case, transmission is performed by a secure route having no risk of tapping.

(3) On the Side of the Authenticating Server U_{A} (Reception, Registration Processing)

The User ID: A and the first-time (next) authentication data E²₍₀₎ are received by the information receiving device 9, and the received data E²₍₀₎ is stored (registered) by the information recording device 10, as an first-time authentication parameter (authentication parameter initial value) Z.

[Authentication Phase]

Next, the authentication phase will now be described. The first time (k=1) authentication procedure will first be described (see FIG. 2).

(1) On the Side of the User U_{B} to be Authenticated (Arithmetic Processing)

N1 is optionally set by the random number generation device 5, and stored by the random number recording device 7. Then, the one-way information generation device 6 generates the intermediate data for next time authentication data E₍₁₎←E (A, S@N₍₁₎), the next time authentication data E²₍₁₎←E (A, E₍₁₎), and the intermediate parameter for certification of authentication E³₍₁₎←E (A, E²₍₁₎).

Then, by using N₍₀₎ stored in the random number recording device 7 in the first-time registration phase, the intermediate data for this time authentication data E₍₀₎←E (A, S@N₍₀₎) is generated, and the this time authentication data E²₍₀₎←E (A, E₍₀₎) is also generated.

Next, the operation device 12 calculates an exclusive OR for this time authentication F₍₀₎=E₍₀₎@E³₍₁₎ is calculated, and an exclusive OR for next time authentication G₍₁₎=E²₍₁₎@E²₍₀₎.

(2) On the Side of the User U_{B} to be Authenticated (Transmission Processing)

The information transmission device 8 transmits the user ID: A, the exclusive OR F₍₀₎ for this time authentication and the exclusive OR G₍₁₎ for next time authentication, to the authenticating server U_{A}. At this time, since the transmission data are encrypted so that only the authenticating person can decrypt, a route having a risk of tapping (general route) such as the Internet may be used.

(3) On the Side of the Authenticating Server U_{A} (Reception, Registration Processing)

User ID: A, the exclusive OR F₍₀₎ for this time authentication and the exclusive OR G₍₁₎ for next time authentication are received, and the operation device 12 generates a temporary parameter Z′ for next time authentication by the following operation:

Z′←G₍₁₎@Z

Here, Z=E²₍₀₎ is an authentication parameter registered in the information recording device 10 in the first-time registration phase. Next, the operation device 12 generates the intermediate parameter W for certification of authentication by the following operation.

W←E (A, Z′)

Next, the operation device 12 generates an intermediate parameter X for validity confirmation using the following operation:

X=F₍₀₎@W

In this exclusive OR operation, when F₍₀₎=E₍₀₎@E³₍₁₎ is the data received from the right user U_{B} to be authenticated, the result of the operation should be X=E₍₀₎.

Then, a parameter Y for validity confirmation is generated by the one-way information generation device 6, from the following operation:

Y←E (A, X)

If the parameter Y for validity confirmation agrees with the authentication parameter Z=E²₍₀₎ stored (registered) in the first-time registration phase, this means that this time authentication is approved, and if these do not agree with each other, authentication is not approved.

(4) On the Side of the Authenticating Server U_{A} (Registration Processing)

If authentication is approved, Z′=E²₍₁₎ is stored (registered) in the information recording device 10 as the authentication parameter Z to be used next time, that is, for the second time authentication. If authentication is not approved, the authentication parameter Z is unchanged.

Generally, the k-th time (k is a positive integer) authentication procedure is as follows.

(1) On the Side of the User U_{B} to be authenticated (arithmetic processing)

N₍ₖ₎ is optionally set by the random number generation device 5, and stored by the random number recording device 7. Then, the one-way information generation device 6 generates the intermediate data for next time authentication data E₍ₖ₎←E (A, S@N₍ₖ₎), the next time authentication data E²₍ₖ₎←E (A, E₍ₖ₎), and the intermediate parameter for certification of authentication E³₍ₖ₎←E (A, E²₍ₖ₎).

Then, by using N₍ₖ₋₁₎ stored in the random number recording device 7 in the previous registration phase, intermediate data for this time authentication data E₍ₖ₋₁₎←E (A, S@N₍ₖ₋₁₎) is generated, and this time authentication data E²₍ₖ₋₁₎←E (A, E₍ₖ₋₁₎) is also generated.

Then, the operation device 12 calculates an exclusive OR for this time authentication F₍ₖ₋₁₎=E₍ₖ₋₁₎@E³₍ₖ₎, and furthermore calculates an exclusive OR for next time authentication G₍ₖ₎=E²₍ₖ₎@E²₍ₖ₋₁₎.

(2) On the Side of the User U_{B} to be Authenticated (Transmission Processing)

The information transmission device 8 transmits to the authenticating server U_{A} the user ID: A, the exclusive OR F₍ₖ₋₁₎ for this time authentication and the exclusive OR G₍ₖ₎ for next time authentication. At this time, since the transmission data is encrypted so that only the authenticating person can decrypt, a route having a risk of tapping (general route) such as the Internet may be used.

(3) On the Side of the Authenticating Server U_{A} (Reception, Registration Processing)

The authenticating server U_{A} receives User ID: A, the exclusive OR F₍ₖ₋₁₎ for this time authentication, and the exclusive OR G₍ₖ₎ for next time authentication, and the operation device 12 calculates the temporary parameter Z′ for next time authentication by the following operation:

Z′←G₍ₖ₎@Z

Here, Z=E²₍₀₎ is the authenticating parameter registered in the information recording device 10 in the previous registration phase. Next, the operation device 12 calculates an intermediate parameter W for certification of authentication by the following operation:

W←E (A, Z′)

Next, an intermediate parameter X for validity confirmation is generated by the operation device 12, from the following operation:

X=F₍ₖ₋₁₎@W

In this exclusive OR operation processing, if F₍ₖ₋₁₎ is the one received from the right user U_{B} to be authenticated, the operation result should be X=E₍ₖ₋₁₎.

Then, a parameter Y for validity confirmation is generated by the one-way information generation device 6, from the following operation:

Y←E (A, X)

If the parameter Y for validity confirmation agrees with the authentication parameter Z=E²₍ₖ₋₁₎ registered in the previous registration phase, this means that this time authentication is approved, and if these do not agree with each other, authentication is not approved.

(4) On the Side of the Authenticating Server U_{A}:

If authentication is approved, Z′=E²₍ₖ₎ is stored (registered) in the information recording device 10 as a new authentication parameter Z to be used next time, by the user to be authenticated having the user ID=A. If authentication is not approved, the authentication parameter Z is unchanged. The authentication of the password of the person to be authenticated is performed by sequentially repeating the above described authentication phase as k=1, 2, 3 and so on.

The effects of the qualification authentication method in this embodiment are as described below.

The exclusive OR F₍ₖ₋₁₎ for this time authentication and the exclusive OR G₍ₖ₎ for next time authentication transmitted by the user U_{B} to be authenticated to the authenticating server U_{A} in the k-th time authentication phase, have been substantially encrypted and associated with each other by the exclusive OR operation with E²₍ₖ₋₁₎ and E³₍ₖ₎ generated by using the one-way function. Therefore, even if these data are illegally tapped, unless the E²₍ₖ₋₁₎ is obtained, actual data cannot be decrypted.

Also, if the exclusive OR F₍ₖ₋₁₎ for this time authentication is changed by illegal operations in communication channels, authentication cannot be approved. Furthermore, because the exclusive OR F₍ₖ₋₁₎ for this time authentication is subjected to exclusive OR operation with E³₍ₖ₎ calculated from the exclusive OR G₍ₖ₎ for next time authentication, if G₍ₖ₎ is changed to false value, the value of E³₍ₖ₎ is also changed. Therefore, it becomes impossible to calculate right E¹₍ₖ₋₁₎ from F₍ₖ₋₁₎, the authentication is not approved, and the partial alternation of data can thereby prevented. Furthermore, if the authentication is not approved, the authentication parameter in the server will not be changed, it is possible to improve the safety in authentication operations.

The exclusive OR G₍ₖ₎ for next time authentication received by the authenticating server U_{A} from the user U_{B} to be authenticated in the k-th time authentication phase are subjected to a kind of encryption by the exclusive OR operation with the authentication parameter Z=E²₍ₖ₋₁₎. However, since E²₍ₖ₋₁₎ has already been registered in the authenticating server U_{A} in the previous authentication phase (in the case of k=1, in the first-time registration phase), the next time authentication parameter Z=E²₍ₖ₎ can be very easily decoded by performing again the exclusive OR operation with E²₍ₖ₋₁₎.

Although the exclusive OR F₍ₖ₋₁₎ for this time authentication is subjected to a kind of encryption by the exclusive OR operation with the intermediate parameter for certification of authentication W=E³₍ₖ₎, because the intermediate parameter for certification of authentication W can be obtained from the next time authentication parameter using the one-way function, the intermediate parameter for validity confirmation X=E₍ₖ₋₁₎ can be easily decrypted. The exclusive OR operation is one of the one-way functions having the simplest operation processing load, and has a characteristic that operation twice enables restoration of the original data.

On the authenticating server side, the data that must be stored (managed) for each user to be authenticated is only the above described authentication parameter Z=E²₍ₖ₋₁₎, and the decoding processing other than the exclusive OR operation that must be executed in the authenticating server for each authentication phase is only two (generation of validity authentication parameter Y and authentication parameter Z), thus enabling reduction in the processing load.

On the side of the user to be authenticated, the encryption processing (use of the one-way function) other than the exclusive OR operation that must be executed for each authentication phase is only five (intermediate data E₍ₖ₋₁₎ for this time authentication, this time authentication data E²₍ₖ₋₁₎, intermediate data E₍ₖ₎ for next time authentication, next time authentication data E²₍ₖ₎, and intermediate parameter for certification of authentication E³₍ₖ₎), and the processing load can be very light.

With the number of information transfers performed between the user to be authenticated and the authenticating server, since the transmission from the user to be authenticated to the authenticating server is only one for each authentication phase, the authentication processing can be reliably performed even in networks with the communication session (connection) being unstable.

Second Embodiment

In the first embodiment, N₍ₖ₎ is optionally set by the random number generation device 5 on the user U_{B} side to be authenticated, and stored by the random number recording device 7, in the k-th time authentication phase. However, in this embodiment, E₍ₖ₎ and E²₍ₖ₎ are stored, instead of N₍ₖ₎. As a result, encryption processing other than the exclusive OR operation that must be executed on the user U_{B} side to be authenticated for each authentication phase, can be reduced to only three.

Third Embodiment

In the first embodiment, at the side of user U_{B} to be authenticated, the random number generation device 5 arbitrarily sets N₍ₖ₎, and the random number recording device 7 stores the N₍ₖ₎. In contrast, in this embodiment, the number of authentications is stored at the side of the authenticating server, a user to be authenticated transmits a user ID to the authenticating server, and the authenticating server sends back the number of authentications stored in the server. By means of using the number of authentications in place of N₍ₖ₋₁₎ and using the number of authentications plus one in place of N₍ₖ₋₎ in the method of the first embodiment, it becomes possible to omit the random number recording device 7. In this case, when the authentication is completed, the authenticating server should store nothing but authentication parameter E²₍ₖ₎ and the number of authentications plus one.

In the above embodiments, the qualification authentication method between the authenticating server U_{A} and the user U_{B} to be authenticated has been described. However, the present invention is also applicable to qualification authentication between Internet users. Needless to say, various modifications are possible without departing from the gist of the present invention.

With the authentication procedures of the above embodiments, the one-way information generation processing on the side to be authenticated need be, for example, only from three to five times for one authentication. This is considerably less than several hundreds to 1,000 times in the Lamport method. Also, even in the CINON method, at the time of executing one authentication processing, transfer of the authentication-related information performed between the person to be authenticated and the authenticating person needs be one round trip and half way (transfer of three times in total), as seen from the person to be authenticated. With the present invention however, only one transmission from the person to be authenticated to the authenticating person is required.

Moreover, in the related art, there are four authentication-related information managed by the authenticating person for each person to be authenticated, but with this method, only one information is necessary.

As described above, with the present invention, the throughput (computational complexity) executed by the person to be authenticated and the authenticating person can be considerably reduced for each authentication phase. Accordingly, as an authentication method for letting the authenticating person authenticate the person to be authenticated on networks where security is not sufficient, there can be provided a method which only requires simple processing, executable with a small program size on the side to be authenticated and the authenticating side, and which can perform safe authentication, strong against tapping and illegal manipulation of information on the communication line.

The qualification authentication method using variable authentication information according to the present invention is applicable to qualification authentication in all situations in networks, communications and computer systems. For example, since the throughput on the side to be authenticated need only be small, this method can be applied to authentication systems for IC cards. By applying this system, it is also applicable to systems such as IC card telephones. It is also applicable to mutual authentication between users of the same level on the network, and to qualification authentication of an access to the information in a database. Moreover, it is applicable to qualification authentication of access to the information of respective groups, when user groups having different interests coexist on the same LAN. In this case, since considerably high speed is required, it is necessary to use an LSI for the private key cryptogram for realizing the one-way conversion processing.

What is claimed is:

1. A qualification authentication method using variable authentication information, comprising an first-time registration phase and an authentication phase;
the first-time registration phase includes:
a step in which a person to be authenticated generates first-time authentication data by using a one-way function which generates output one-way information which makes it difficult to calculate input information in terms of computational complexity, based on an own user ID, password and a random number;
a step in which the person to be authenticated transmits an own user ID and the first-time authentication data to the authenticating person; and
a step in which the authenticating person registers the first-time authentication data received from the person to be authenticated as an authentication parameter used at the time of first-time authentication; and
the authentication phase includes:
a step in which the person to be authenticated generates, intermediate data for this time authentication data, this time authentication data, next time authentication data, and an intermediate parameter for certification of authentication, using the one-way function based on the own user ID, password and a random number; and performs an exclusive OR operation using the intermediate parameter for certification of authentication, with respect to the intermediate data for this time authentication data, and an exclusive OR operation using the this time authentication data with respect to the next time authentication data, to thereby generate an exclusive OR for this time authentication and an exclusive OR for next time authentication;
a step in which the person to be authenticated transmits the own user ID, the exclusive OR for this time authentication and the exclusive OR for next time authentication to the authenticating person;
a step in which the authenticating person generates a temporary parameter for next time certification based on the exclusive OR of the exclusive OR for next time authentication received from the person to be authenticated and the authentication parameter registered in the previous time, and generates an intermediate parameter for certification of authentication using the one-way function from the temporary parameter for next time authentication;
a step in which the authenticating person generates a validity confirmation parameter for the person to be authenticated, using the one-way function and designating, as the input information, an exclusive OR of the exclusive OR for this time authentication received from the person to be authenticated and the intermediate parameter for certification of authentication, compares the validity confirmation parameter and the previously registered authentication parameter, and if these parameters agree with each other, the authenticating person judges that the authentication is approved, and if these parameters do not agree with each other, the authenticating person judges that the authentication is not approved; and
a step in which when the authentication is approved, the temporary parameter for next time authentication is registered as an authentication parameter for next time authentication instead of the previously registered authentication parameter.

2. A qualification authentication method according to claim 1, wherein a function for private key cryptography is used as the one-way function E.

3. A qualification authentication method according to claim 1, wherein DES or FEAL function is used as the one-way function E.
